(19) United States
(12) Patent Application Publication
(10) Pub. No.: US 2021/0398347 A1
(43) Pub. Date: Dec. 23, 2021

(54) Systems and Methods for Generating Property Data Packages from Lidar Point Clouds

(71) Applicant: Insurance Services Office, Inc., Jersey City, NJ (US)

(72) Inventors: Bryce Zachary Porter, Lehi, UT (US); Francisco Rivas, Móstoles, Madrid (ES); Ryan Mark Justus, Lehi, UT (US)

(73) Assignee: Insurance Services Office, Inc., Jersey City, NJ (US)

(21) Appl. No.: 17/355,995

(22) Filed: Jun. 23, 2021

Related U.S. Application Data
(60) Provisional application No. 63/042,802, filed on Jun. 23, 2020.

(51) Int. Cl. G06T 17/05; G06T 17/20

(52) U.S. Cl. CPC G06T 17/05; G06T 2200/24; G06T 17/20

(57) ABSTRACT

Systems and methods for generating property data packages from light detection and ranging (“LIDAR”) point clouds are provided. Data from the LIDAR systems is stored in a LIDAR database in communication with a computer processor that executes computer vision system code including a 3D point cloud model generator, a measurement tool(s) subsystem, a 3D wireframe model generator, and a measurement extraction subsystem. The system receives an indication of a region of interest (“ROI”) from a user, retrieves point cloud data associated with the ROI from the LIDAR database, generates a 3D point cloud model based on the point cloud data, generates a 3D wireframe model based on the 3D point cloud model and operator input, extracts measurement information from the 3D wireframe model, and transmits a data package to the user. The data package can include, but is not limited to, the 3D point cloud model, the 3D wireframe model, and the extracted measurement data.

### RELATED APPLICATIONS

This application claims priority to U.S. Provisional Patent Application Ser. No. 63/042,802 filed on Jun. 23, 2020, the entire disclosure of which is hereby expressly incorporated by reference.

### BACKGROUND

### Technical Field

The present disclosure relates generally to the field of computer modeling of structures. More specifically, the present disclosure relates to systems and methods for generating property data packages from light detection and ranging (“LIDAR”) point clouds.

### Related Art

Accurate and rapid identification and depiction of objects from aerial imagery is increasingly important for a variety of applications. For example, information related to the roofs of buildings is often used by construction professionals to specify materials and associated costs for both newly-constructed buildings, as well as for replacing and upgrading existing structures. Further, in the insurance industry, accurate information about structures may be used to determine the proper costs for insuring buildings/structures. Still further, government entities can use information about the known objects in a specified area for planning projects such as zoning, construction, parks and recreation, housing projects, etc.

Various software systems have been implemented to process aerial images to generate three dimensional (“3D”) models of structures present in the aerial images. However, these systems have drawbacks, such as an inability to accurately depict areas of structures that are obstructed from view, such as by trees, bushes, and the like. This may result in an inaccurate or an incomplete 3D model of the structure.

Thus, in view of existing technology in this field, what would be desirable is a system that reliably and efficiently generates a complete 3D model of a structure present in a given region of interest. Accordingly, the systems and methods disclosed herein solve these and other needs.

### SUMMARY

The present disclosure relates to systems and methods for generating property data packages from light detection and ranging (“LIDAR”) point clouds. Data from the LIDAR systems is stored in a LIDAR database in communication with a computer processor that executes computer vision system code including a 3D point cloud model generator, a measurement tool(s) subsystem, a 3D wireframe model generator, and a measurement extraction subsystem. The system receives an indication of a region of interest (“ROI”) from a user, retrieves point cloud data associated with the ROI from the LIDAR database, generates a 3D point cloud model based on the point cloud data, generates a 3D wireframe model based on the 3D point cloud model and operator input, extracts measurement information from the 3D wireframe model, and transmits a data package to the user. The data package can include, but is not limited to, the 3D point cloud model, the 3D wireframe model, and the extracted measurement data.

The system of the present disclosure includes a graphical user interface that displays the 3D point cloud model and one or more measurement tools that can be displayed over the 3D point cloud model and which receive input from the operator. The operator can manipulate the measurement tools to align them with the underlying 3D point cloud model, thereby generating a 3D wireframe model representation of a structure. The measurement tools can include roof measurement tools, wall measurement tools, wall element tools, roof element tools, and ground element tools.

Advantages of the system of the present disclosure include the ability to generate 3D representations of a wide variety of structures and with greater accuracy than traditional systems, especially with respect to structures obstructed by trees, bushes, or the like.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating hardware and software components capable of being utilized to implement the system of the present disclosure;

FIG. 2 is a flowchart illustrating overall process steps carried out by the system of the present disclosure;

FIG. 3 is a flowchart illustrating step 108 of FIG. 2 in greater detail;

FIG. 4 is a diagram illustrating a 3D point cloud model for a region of interest and a 3D wireframe model corresponding thereto; and

FIG. 5 is a diagram illustrating additional aspects of the system of the present disclosure.

### DETAILED DESCRIPTION

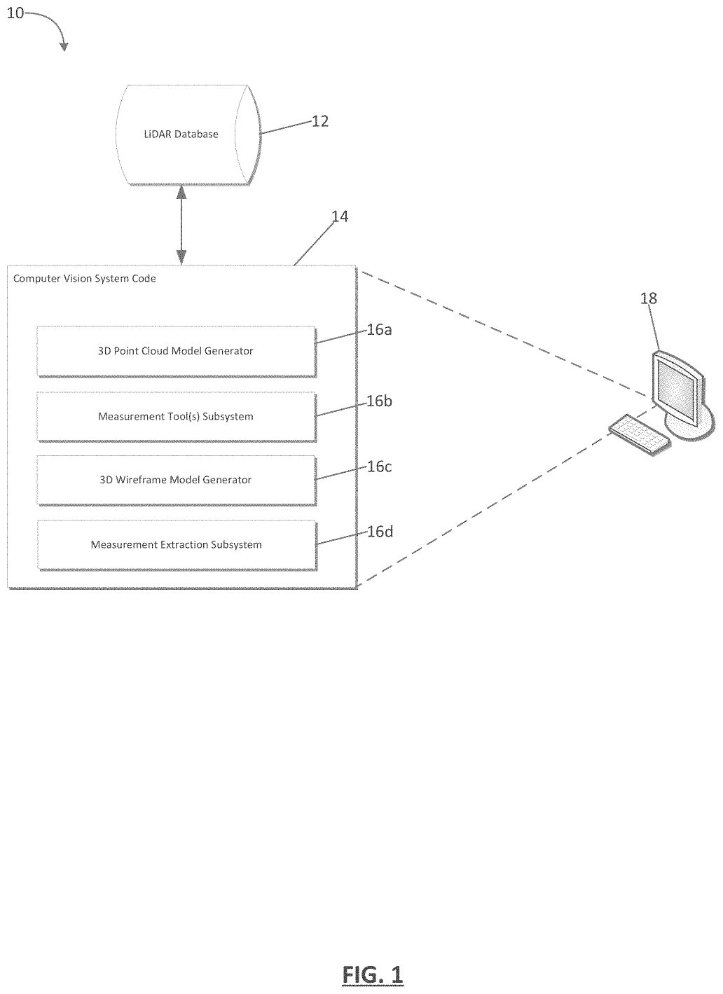

This present disclosure relates to systems and methods for generating property data packages from point clouds, as described in detail below in connection with FIGS. 1-5.

The embodiments described below are related to constructing a 3D roof geometry in real-world coordinates and refer to a roof of a structure in one or more images. It should be understood that any reference to the roof of the structure is only by way of example, and that the systems, methods and embodiments discussed throughout this disclosure may be applied to any structure or property feature, including but not limited to, roofs, walls, buildings, awnings, houses, decks, pools, temporary structures such as tents, motor vehicles, foundations, and the like. Additionally, although the present disclosure is discussed in connection with LIDAR point clouds, it is noted that the systems and methods disclosed herein can operate with non-LIDAR point clouds.

FIG. 1 is a diagram illustrating hardware and software components capable of being utilized to implement the system 10 of the present disclosure. The system 10 can be embodied as a computer system 18 (e.g., a hardware processor) in communication with a LIDAR database 12. The computer system 18 executes system code which generates a 3D geometric model of a structure based on point cloud data stored in the LIDAR database 12. The computer system 18 could include, but is not limited to, a personal computer, a laptop computer, a tablet computer, a smart telephone, a server, and/or a cloud-based computing platform.

The system 10 includes computer vision system code 14 (non-transitory, computer-readable instructions) stored on a computer-readable medium and executable by a processor of one or more computer systems. The code 14 could include various custom-written software subsystems that carry out the steps/processes discussed herein, and could include, but is not limited to, a 3D point cloud model generator module 16a, a 3D wireframe model generator module 16b, and a measurement data extraction subsystem 16c. The code 14 could be programmed using any suitable programming languages including, but not limited to, C, C++, C#, Java, Python or any other suitable language. Additionally, the code could be distributed across multiple computer systems in communication with each other over a communications network, and/or stored and executed on a cloud computing platform and remotely accessed by a computer system in communication with the cloud platform. The code could communicate with the LIDAR database 12, which could be stored on the same computer system as the code 14, or on one or more other computer systems in communication with the code 14.

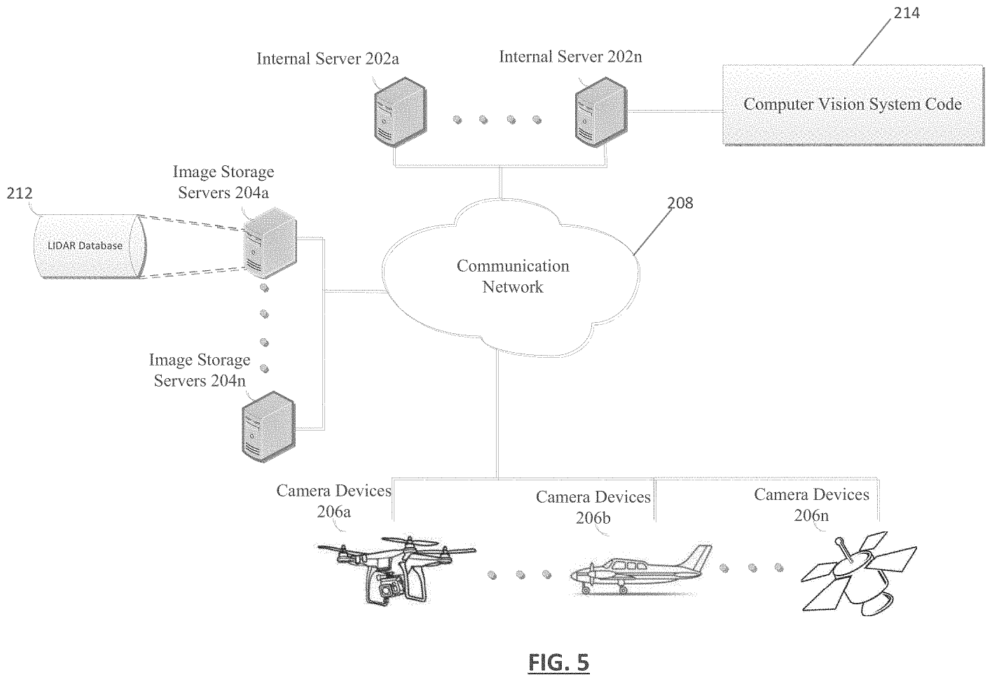

Still further, the system 10 could be embodied as a customized hardware component such as a field-programmable gate array (“FPGA”), application-specific integrated circuit (“ASIC”), embedded system, or other customized hardware component without departing from the spirit or scope of the present disclosure. It should be understood that FIG. 1 is only one potential configuration, and the system 10 of the present disclosure can be implemented using a number of different configurations. Additional configurations are discussed in connection with FIG. 5 hereinbelow.

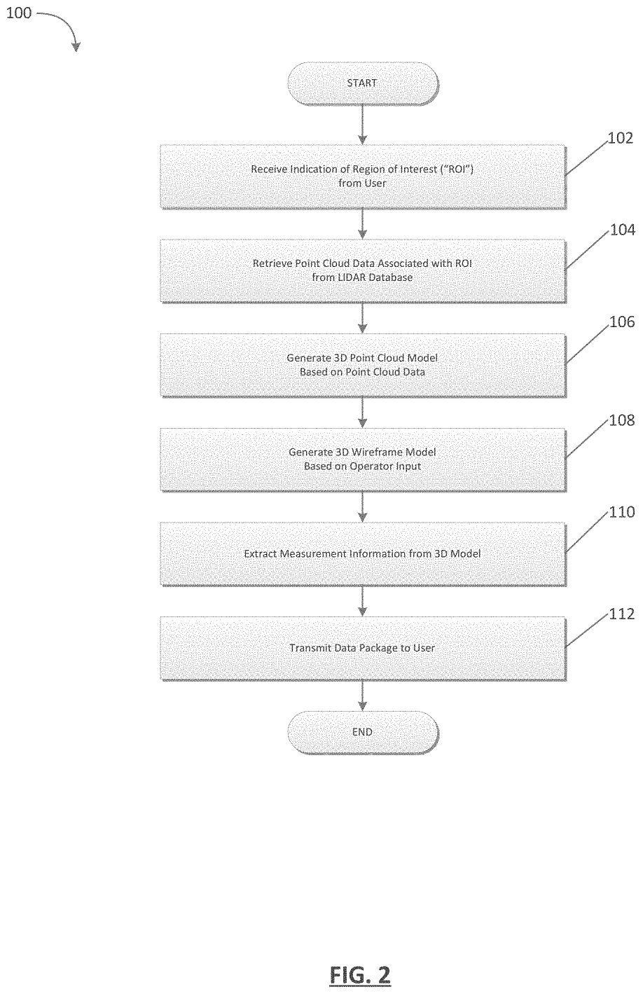

FIG. 2 is a flowchart illustrating the overall process steps 100 carried out by the system 10 of the present disclosure. In step 102, the system 10 receives an indication of a geospatial region of interest (“ROI”) specified by a user. For example, a user can submit a data package request for a given ROI through a web portal, or other interactive user interface configured to receive data from the user. As will be discussed in greater detail below, a data package can include, but is not limited to, a 3D point cloud model of the ROI, a 3D wireframe model of one or more structures within the ROI, and measurement information extracted from the models. The user can indicate the location of the ROI by inputting latitude and longitude coordinates of the ROI. The region can be of interest to the user because of one or more specific structures present in the region, or because of aspects of the region itself. Accordingly, the geospatial ROI can be represented as a polygon bounded by latitude and longitude coordinates. In a first example, the polygon can be a rectangle or any other shape centered on a postal address. In a second example, the bounds can be determined from survey data of property parcel boundaries. In a third example, the bounds can be determined by a selection of the user (e.g., in a geospatial mapping interface). Those skilled in the art will understand that other methods can be used to determine the bounds of the polygon. The ROI may be represented in any computer format, such as, for example, well-known text (“WKT”) data, TeX data, Lamport TeX (“LaTeX”) data, HTML data, XML data, etc. The same interface used to receive the ROI location from the user can also be used by the system 10 to collect identification information and contact information from the user.

In step 104, the system 10 retrieves point cloud data associated with the ROI from the LIDAR database. The point cloud data includes multiple data points that can be collected using various LiDAR systems over a period of time (e.g., annually), which can be stored in the LIDAR database for retrieval by the system 10. A sample LIDAR system that can be employed for the collection of point cloud data is described below.

LIDAR systems use beams of light reflected off surfaces to acquire the data points, which are used to create a point cloud. A LIDAR system generally consists of four main components: 1) a laser and sensing device; 2) a GPS (Global Positioning System); 3) an IMU (Inertial Measurement Units) detector; and 4) a computer processor. Beams of light are sent from the laser, which is mounted to the underbelly of an aircraft, unmanned aerial vehicle (“UAV”), or the like, to the surface of the earth (e.g., towards the ground, a surface of a structure, tree, or the like). The laser pulses several times per second and oscillates from side to side. The time at which a pulse is sent is subtracted from the time at which the pulse returns, and thus the distance from the laser to the surface is calculated. The angle at which the laser is orientated at every pulse is recorded and factored into the calculation, such that the calculated distance to an object also includes a corresponding direction relative to the laser. Furthermore, the GPS unit is used to calculate the location of the aircraft at every pulse and the IMU detector, which is a combination of sensors that measure acceleration (change in motion) in three dimensions, is used to determine changes in the x/y/z positions (e.g., yaw, pitch, and roll) as the aircraft travels along its flight path.

The LiDAR system uses the computer processor to combine and interpret the data gathered from the laser/detector, GPS unit, and IMU detector and outputs a data point for each pulse that includes a precise latitude, longitude, and altitude (e.g., a point on a 3D coordinate system). Thousands, or even millions, of these data points can be gathered and recorded in the LIDAR database 12. In addition to data points derived from a LIDAR system as discussed above, the system 10 of the present disclosure can also utilize 3D data points derived from other sources. For example, those of ordinary skill in the art will understand that 3D data points can also be derived from digital photographic aerial images, using well-known photogrammetric principles, and stored in a database for retrieval by the system 10.

After the system 10 receives the indication of the ROI from the user in step 102, the system 10 can automatically retrieve the data points associated with the ROI from the LIDAR database in step 104. In step 106, the system 10 generates a 3D point cloud model based on the data points retrieved from the LIDAR database. More specifically, the system 10 can apply surface reconstruction algorithms to the discrete LIDAR data points, which form a point cloud with open surface geometries, in order to generate the 3D point cloud model, having solid surface geometries. The 3D point cloud model can be manipulated (e.g., rotated, zoomed in/out, etc.) by an operator in order to inspect the model from a more advantageous viewpoint. As will be understood to those of ordinary skill in the art, the greater the number of LiDAR data points available for a given ROI, the more accurate the 3D point cloud model will be. For example, if a sufficient number of data points are available to the system 10 for generation of the 3D point cloud model, minute details of a structure can be seen, including but not limited to, roof vents, roof materials, and rain gutters. Furthermore, because the data points are derived from a LIDAR system, the 3D point cloud model can show accurate structural details in areas that are, at least in part, obstructed by trees, bushes, and other structures. For example, if a tree is obscuring a portion of a building, it is still possible to show obscured features of the building (e.g., doors, windows, etc.) in the 3D point cloud model. This is because the individual LIDAR data points are gathered from a plurality of different positions as the aircraft travels along its flight path, a number of which will have clear lines of sight to features that may be obstructed from a particular viewpoint. Further still, unlike traditional aerial imagery systems that require the triangulation of two or more aerial images to obtain 3D data, a LIDAR system directly acquires 3D data for each pulse of the laser, increasing the likelihood of obtaining data for an obscured feature.

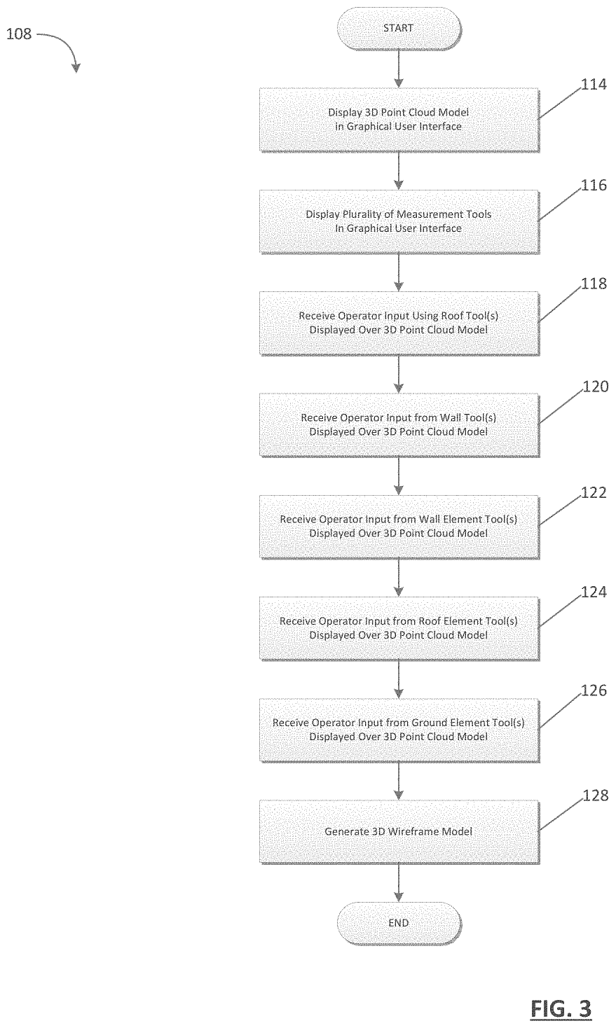

In step 108, the system 10 generates a 3D wireframe model on top of the 3D point cloud model, based on operator input. Referring to FIG. 3, step 108 of FIG. 2 is described in greater detail. As shown, in step 114, the system 10 displays the 3D point cloud model in a graphical user interface (“GUI”). In step 116, the system displays a plurality of measurement tools in the GUI that are configured to receive input from the operator. Then, in step 118, the system 10 receives input from an operator using one or more roof tools that are displayed over the 3D point cloud model. In step 120, the system 10 receives input from an operator using one or more wall tools that are displayed over the 3D point cloud model, and in step 122, the system 10 receives input from an operator using one or more wall element tools that are displayed over the 3D point cloud model. In step 124, the system 10 receives input from an operator using one or more roof element tools that are displayed over the 3D point cloud model. Next, in step 126, the system 10 receives input from an operator using one or more ground element tools that are displayed over the 3D point cloud model. Finally, in step 128, the system 10 generates a 3D wireframe model based on the information received from the measurement tools. Various aspects of the measurement tools are described hereinbelow.

With regard to step 118, the system 10 can include a plurality of roof measurement tools that are displayed over the 3D point cloud model, which are manipulated by the operator. The information received via the roof measurement tools is used by the system 10, in combination with information provided by one or more additional measurement tools, to generate a 3D wireframe model representation of one or more structures within the ROI. For example, the roof measurement tools can be representative of a plurality of roof configurations, including shed roofs, gable roofs, hip roofs, turret roofs, and non-conventional roofs. The tools can be presented in the GUI as a series of lines intersecting each other, forming wireframe shapes corresponding to the various roof configurations. In operation, an operator selects a roof measurement tool that approximates the shape of a roof shown in the 3D point cloud model, displayed in the same GUI, and adjusts the roof measurement tool to match the 3D point cloud model. According to some aspects of the present disclosure, the roof measurement tools include points where the lines intersect, called nodes, which can be manipulated (e.g., moved, grabbed, shifted, etc.) by the operator to more accurately reflect a particular roof feature. For example, the operator can use a mouse, or other pointing device, to click (and hold) on a particular node and drag the node to adjusts its position. If additional roof sections need to be added to the 3D wireframe model, the nodes act as guide points, such that a additional wireframe roof measurement tool can be “snapped” to an existing tool, thereby sharing one or more nodes. For any incongruities or abnormal situations that occur on a roof, the roof measurement tools can also include a draw tool to create custom lines from basic shapes. The draw tool can also be used in conjunction with a delete tool to create cut outs on roofs. The operator can also extend the roof wireframe using an extension tool. If some roofs are symmetrical to each other in size and shape, the system 10 can include a copy tool to copy a wireframe that has already been generated for one roof onto another roof. Additionally, the system 10 can include tools that are used to draw objects on roofs, such as, for example, a gable return tool, a chimney tool, and a cricket tool. After the wireframe of the roof has been generated, the system 10 can proceed to step 120, where the walls of the 3D wireframe model are constructed.

With regard to step 120, the system 10 can include a plurality of wall measurement tools that are displayed over the 3D point cloud model, which can be manipulated by the operator. According to some aspects of the present disclosure, the system 10 can automatically generate walls of the 3D wireframe model based on an outside edge, or perimeter, of the roofs. For example, the system 10 can generate walls that originate from the perimeters of the roofs, offset by a predetermined distance to accommodate a roof overhang. More specifically, the system 10 can offset the walls from the edge of the perimeter by 18 inches, which is the most common overhang for a roof, or another overhang distance specified by the user. The system 10 can determine the height of the walls based off a ground point provided by the operator. Of course, the overhang dimension, height of the walls, and the like can also be modified by the operator. For example, the walls can be adjusted in the XY plane (e.g., horizontally) using an overhang tool and a push/pull wall tool. These tools can adjust the entire wall in XY plane based on a comparison to the 3D point cloud model by the operator. Small sections or portions of the walls can be adjusted using a push/pull wall rectangle tool. Similarly, the walls can be adjusted along the Z axis (e.g., height dimension) by grabbing nodes on the bottoms of the walls and moving them. In addition to these tools, there are also tools for copying walls, modeling apertures in walls, and creating no thickness walls. The tool for copying walls can be similar to the tool for copying roofs, described above. Further, the wall aperture tool can delete a rectangular section of wall, and the no thickness wall tool can be used to create custom walls that are seen on structures. After the walls have been modeled, the system 10 can proceed to step 122, where wall elements of the 3D wireframe model are generated.

With regard to step 122, the system 10 can include a plurality of wall element measurement tools that are displayed over the 3D point cloud model, which can be manipulated by the operator. More specifically, the wall element tools are utilized by the operator to construct doors, windows, and attic vents on the 3D wireframe model. The wall element tools can include a set of shapes for doors, provided in standard door sizes, such as a three (3) feet by 6.8 feet. The operator can position doors anywhere on the walls of the 3D wireframe model. Once the door has been positioned, the operator can use nodes of the door to adjust its size, as described above, in the event that the door is smaller or larger than the door shown on the underlying 3D point cloud model. Windows and attic vents are positioned on the walls using a similar procedure. However, as these wall elements may not conform to standard sizes, the operator can also model them based on the 3D point cloud model using a free form tool. Standard shapes for windows and attic vents can be adjusted to any corresponding shape shown on the underlying 3D point cloud model as well. After the wall elements have been modeled, the system 10 can proceed to step 124, where roof elements of the 3D wireframe model are generated.

With regard to step 124, the system 10 can include a plurality of roof element tools and tags that are displayed over the 3D point cloud model, which can be manipulated by the operator. More specifically, the roof element tools and tags are utilized by the operator to indicate roof vents, satellite dishes, skylights, roofing panels, rain gutters, and the like on the 3D wireframe model. The operator can indicate roof vents, satellite dishes, and air conditioning units identified on the 3D point cloud model by tagging each element using a set of tags provided by the system 10 in the GUI. Rain gutters can be automatically generated by the system 10, using the perimeter of the roof as a guide. Of course, the operator can adjust the rain gutters to conform with rain gutters shown in the 3D point cloud model, if necessary, using any of the adjustment techniques described herein. Skylights and roofing panels each have wireframe measurement tools which can be positioned on the roof by the operator, similar to the procedure for positioning and adjusting windows and doors. After the wall elements have been modeled and/or tagged, the system 10 can proceed to step 126, where ground elements of the 3D wireframe model are indicated.

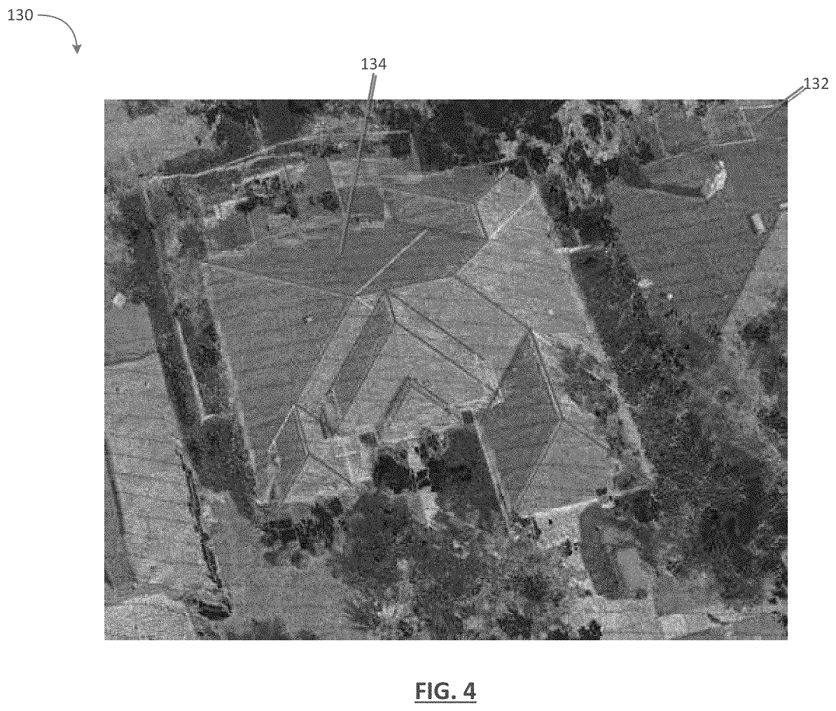

With regard to step 126, the system 10 can include a plurality of ground element tools and tags that are displayed over the 3D point cloud model, which can be manipulated by the operator. More specifically, the ground element tools and tags are utilized by the operator to indicate porches, pools, trampolines, trees, and the like on the 3D wireframe model. Structures such as porches are generated using the roof measurement tools described above and can then then be tagged with a specific porch tag. Pools, trampolines, and trees can tagged to identify that they exist within the ROI. These elements can also be modeled as adjustable wireframes and can cover portions of the 3D wireframe structure when modeled. After the ground elements have been modeled and/or tagged, the system 10 can proceed to step 128, where the system 10 generates the 3D wireframe model based on the information received from the measurement tools and tags described in connection with steps 116-126 of FIG. 3. FIG. 4 is a diagram illustrating a GUI 130 displaying a 3D point cloud model 132 for a region of interest and a 3d wireframe model 134 formed thereon.

Returning to FIG. 2, after the 3D wireframe model is generated, the system 10 proceeds to step 110, where measurement information is extracted from the 3D wireframe model. General measurement information can be automatically extracted, or alternatively, measurement information that is specifically requested by a user can be extracted. The measurement information can include, but is not limited to, roof area, length of flashing and step flashing, length of valley, eave, hip and ridge roof lines, roof drip edge length, number of squares, predominant pitch, length of cornice strips, overhang length, rain gutter location and length, and per face statistics that include face area, pitch, and line type lengths. This data can be derived by the system 10 from the 3D geometry of the models. Of course, the data can be serialized into JSON, XML, CSV or other machine and human readable formats.

The system 10 can automatically extract accurate measurement data based on the geometric relationships between the 3D wireframe model, the 3D point cloud model, and the tags. This is possible because the system 10 knows the locations of the 3D wireframe model, tags, and 3D cloud point model relative to one another, and can thus extrapolate measurement information. According to one specific example, once the roof of the 3D wireframe model has been generated based on the 3D point cloud model using the associated roof measurement tool(s), the system 10 can employ trigonometric principles to calculate the dimensions, angles, slopes, and other dimensions of the roof. Similarly, the system 10 can use the information provided by the wall measurement tool(s) and calculate the dimensions of the walls of the 3D wireframe model. The System 10 can also extract measurement data using information associated with the tags, discussed above. Specifically, the system 10 can identify one or more of the tags positioned by the operator, tabulate this information, and calculate the measurements for the tagged elements. In another example, the system 10 calculates the length of the rain gutters based on the wireframe model of the roof, more specifically, the perimeter thereof. According to a further example, pools, trampolines, trees and other ground elements do not have measurement data extracted directly, but are tagged to identify that they exist as part of the ROI. However, as described above, these ground elements can cover portions of the 3D wireframe model. As such, the percentage of the 3D wireframe model obstructed can also be calculated by the system 10.

In step 112, the system 10 transmits a data package to the user. The data package can comprise a data file container and can include one or more of the measurement information, the 3D point cloud model, the 3D wireframe model, and additional information regarding the ROI. As will be understood by those of ordinary skill in the art, that data package can be transmitted to the user via a network connection, which could include, but is not limited to, the Internet. Alternatively, the data package could be stored on a physical storage media (e.g., flash drive, portable hard drive, etc.) and physically transported to the user.

FIG. 5 is a diagram illustrating system 200 of the present disclosure. In particular, FIG. 5 illustrates computer hardware and network components on which the system 200 can be implemented. The system 200 can include a plurality of internal servers 202a-202n having at least one processor and memory for executing the computer instructions and methods described above (which could be embodied as computer vision system code 214, similar to computer vision system code 14, described herein). The system 200 can also include a plurality of storage servers 204a-204n for receiving and storing LIDAR image data. According to some aspects of the present disclosure, a LIDAR database 212 can be stored on servers 204a-204n. The system 200 can also include a plurality of devices 206a-206n equipped with LIDAR systems for capturing LIDAR data. For example, the camera devices can include, but are not limited to, a unmanned aerial vehicle 206a, an airplane 206b, and a satellite 206n. The internal servers 202a-202n, the storage servers 204a-204n, and the camera devices 206a-206n can communicate over a communication network 208 (e.g., the Internet). Of course, the system 200 need not be implemented on multiple devices, and indeed, the system 200 could be implemented on a single computer system (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A method for generating a data package from point cloud data, comprising the steps of:
receiving an indication of a region of interest from a user;
retrieving from a database point cloud data associated with the region of interest;
generating a three-dimensional (3D) point cloud model based on the point cloud data;
generating a 3D wireframe model on top of the 3D point cloud model based on user input;
extracting measurement information from the 3D wireframe model; and
generating and transmitting a data package including at least one of the measurement information, the 3D point cloud model, or the 3D wireframe model.

2. The method of claim 1, wherein the point cloud data comprises light detection and ranging (LIDAR) point cloud data.

3. The method of claim 1, wherein the step of generating the 3D wireframe model comprises displaying the 3D point cloud model and at least one measurement tool over the 3D point cloud model in a graphical user interface.

4. The method of claim 3, wherein the at least one measurement tool comprises a roof tool and further comprising receiving operator input using the roof tool.

5. The method of claim 3, wherein the at least one measurement tool comprises a wall tool and further comprising receiving operator input using the wall tool.

6. The method of claim 3, wherein the at least one measurement tool comprises a wall element tool and further comprising receiving operator input using the wall element tool.

7. The method of claim 3, wherein the at least one measurement tool comprises a roof element tool and further comprising receiving operator input using the roof element tool.

8. The method of claim 3, wherein the at least one measurement tool comprises a ground element tool and further comprising receiving operator input using the ground element tool.

9. The method of claim 3, wherein the 3D wireframe model is generated based on operator input provided using the at least one measurement tool.

10. The method of claim 1, wherein the measurement information comprises one or measurements of one or more features of a structure.

11. A system for generating a data package from point cloud data, comprising:
a database storing point cloud data; and
a processor in communication with the database, the processor programmed to perform the steps of:
receiving an indication of a region of interest from a user;
retrieving from the database point cloud data associated with the region of interest;
generating a three-dimensional (3D) point cloud model based on the point cloud data;
generating a 3D wireframe model on top of the 3D point cloud model based on user input;
extracting measurement information from the 3D wireframe model; and
generating and transmitting a data package including at least one of the measurement information, the 3D point cloud model, or the 3D wireframe model.

12. The system of claim 11, wherein the point cloud data comprises light detection and ranging (LIDAR) point cloud data.

13. The system of claim 11, wherein the step of generating the 3D wireframe model comprises displaying the 3D point cloud model and at least one measurement tool over the 3D point cloud model in a graphical user interface.

14. The system of claim 13, wherein the at least one measurement tool comprises a roof tool and the processor further performs the step of receiving operator input using the roof tool.

15. The system of claim 13, wherein the at least one measurement tool comprises a wall tool and the processor further performs the step of receiving operator input using the wall tool.

16. The system of claim 13, wherein the at least one measurement tool comprises a wall element tool and the processor further performs the step of receiving operator input using the wall element tool.

17. The system of claim 13, wherein the at least one measurement tool comprises a roof element tool and the processor further performs the step of receiving operator input using the roof element tool.

18. The system of claim 13, wherein the at least one measurement tool comprises a ground element tool and the processor further performs the step of receiving operator input using the ground element tool.

19. The system of claim 13, wherein the 3D wireframe model is generated based on operator input provided using the at least one measurement tool.

20. The system of claim 13, wherein the measurement information comprises one or measurements of one or more features of a structure.
